(19) United States
(12) Patent Application Publication
(10) Pub. No.: US 2004/0183970 A1
(43) Pub. Date: Sep. 23, 2004

(54) Semi-transmissive display apparatus

(76) Inventor: Hirotaka Niiya, Nara (JP)

Correspondence Address: NIXON & VANDERHYE, PC, 1100 N GLEBE ROAD, 8TH FLOOR, ARLINGTON, VA, 22201-4714, US

(21) Appl. No.: 10/779,779

(22) Filed: Feb. 18, 2004

(30) Foreign Application Priority Data
Feb. 19, 2003 (JP) 2003-040951

(51) Int. Cl. G02F 1/1335

(52) U.S. Cl. 349/114

(57) ABSTRACT

The present invention provides a semi-transmissive display apparatus, in which a plurality of pixels, each including a transmissive region and a reflective region, are arranged in a matrix pattern, the apparatus including: a device substrate including, for each of the plurality of pixels, a transparent electrode forming the transmissive region, a reflective plate forming the reflective region, and a switching device; a counter substrate including a common counter electrode and opposing the device substrate; and a display layer interposed between the device substrate and the counter substrate, wherein the device substrate is provided with a color filter.

### BACKGROUND OF THE INVENTION

1. Field of the Invention

The present invention relates to a semi-transmissive display apparatus, and more particularly to a display apparatus having a color-filter-on-array structure, in which the switching devices and the color filter are provided on the same substrate.

2. Description of the Background Art

Liquid crystal display apparatuses are a type of display apparatus that has been attracting public attention. For their advantageous features such as a small thickness and a small power consumption, they have been used in a wide variety of applications, including OA equipment such as personal computers, camcorders equipped with liquid crystal display monitors, and portable information devices such as mobile phones, and PDAs (Personal Digital Assistants).

A common liquid crystal display apparatus includes a device substrate on which pixel electrodes are arranged in a matrix pattern, and a counter substrate including a color filter having filter portions of three primary colors (red, green and blue) and a black matrix for optically separating filter portions of different colors from one another. The device substrate and the counter substrate are attached to each other so that elements on one substrate are aligned with those on the other, i.e., so that the pixel electrodes on the device substrate and the filter portions of the color filter on the counter substrate are precisely aligned with each other.

In order to properly attach the device substrate and the counter substrate to each other, it is necessary to provide some attachment margin for accommodating possible displacements. Therefore, it is usually the case that the light-blocking black matrix covering the gaps between filter portions of different colors extends so as to overlap the pixel electrodes on the opposing device substrate by a few microns. Thus, there is a design limitation on the aperture ratio of a liquid crystal display apparatus.

Moreover, in order to realize a high-definition display, it is necessary to reduce the size of one pixel, which is the minimum element of an image. However, as the size of one pixel decreases, the lines, the switching devices, the black matrix, etc., occupy a greater area with respect to the total area of the pixel. Thus, reducing the size of one pixel also reduces the aperture ratio.

In view of this, another type of liquid crystal display apparatuses aiming at increasing the definition and the aperture ratio have been proposed in the art, as disclosed in Japanese Laid-Open Patent Publication No. 2-54217.

Japanese Laid-Open Patent Publication No. 2-54217 discloses a liquid crystal display apparatus employing a so-called “color-filter-on-array structure”, in which the color filter is provided on the same substrate where the switching devices are provided.

The display device will now be described more specifically with reference to FIG. 4.

A liquid crystal display apparatus 30 includes a counter substrate 22, a TFT array substrate 23, and a liquid crystal layer 12 interposed therebetween. The counter substrate 22 includes a glass substrate 11 and a common counter electrode 10, and the TFT array substrate 23 includes TFTs (Thin Film Transistors) 24 as switching devices provided thereon.

In the TFT array substrate 23, the TFT 24, including a gate electrode 1, a source electrode 4, a drain electrode 5, etc., is provided on the glass substrate 11, and a black matrix 7 is provided over the TFT 24, with a color filter 9 being provided on the glass substrate 11 except for where the TFT 24 is provided. Moreover, a pixel electrode 8, connected to the drain electrode 5 of the TFT 24, is provided over the black matrix 7 and the color filter 9.

In the liquid crystal display apparatus 30, the pixel electrode 8 and the color filter 9 are integrated together, whereby there is little displacement between the pixel electrode 8 and the corresponding filter portion of the color filter 9, thus minimizing the line width of the black matrix 7. In the example illustrated in FIG. 4, the black matrix 7 is provided so as to cover the TFT 24, whereby it functions also as a light-blocking film for the TFT 24. On the other hand, the counter substrate 22 to be attached to the TFT array substrate 23 has a simple structure where the common counter electrode 10 is provided on the glass substrate 11, and is not structurally divided into pixels. Therefore, this structure hardly requires any attachment margin. Thus, it is possible to realize a display apparatus that has both a high definition and a high aperture ratio.

This is an example where a color-filter-on-array structure is applied to a transmissive liquid crystal display apparatus.

However, a transmissive liquid crystal display apparatus typically includes a backlight, which consumes 50% or more of the total amount of power consumed. Therefore, the provision of a backlight significantly increases the total power consumption.

In view of this, reflective liquid crystal display apparatuses, which make use of the reflection of the ambient light and consume less power, are also widely used in the art. Japanese Laid-Open Patent Publication No. 2000-162625 discloses a reflective liquid crystal display apparatus employing a color-filter-on-array structure.

The display apparatus will now be described more specifically with reference to FIG. 5.

In the TFT array substrate 23 of the liquid crystal display apparatus 30, a reflective electrode 20 connected to the drain electrode 5 of the TFT 24 is provided on an interlayer insulating film 14, and the transparent electrode 8 connected to the reflective electrode 20 is provided over the reflective electrode 20, with the color filter 9 being provided between the electrodes.

In the liquid crystal display apparatus 30, as in the previous example of a transmissive display apparatus, the pixel electrode 8 and the color filter 9 are integrated together, whereby there is little displacement between the pixel electrode 8 and the corresponding filter portion of the color filter 9, thus minimizing the line width of the black matrix 7. On the other hand, the counter substrate 22 to be attached to the TFT array substrate 23 has a simple structure where the common counter electrode 10 is provided on the glass substrate 11, and is not structurally divided into pixels. Therefore, this structure hardly requires any attachment margin. Thus, it is possible to realize a display apparatus that has both a high definition and a high aperture ratio.

This is an example where a color-filter-on-array structure is applied to a reflective liquid crystal display apparatus.

However, a reflective liquid crystal display apparatus has a disadvantage in that the visibility thereof is very low when used in environments with little ambient light. In view of this, Japanese Laid-Open Patent Publication No. 11-101992 discloses a semi-transmissive liquid crystal display apparatus capable of displaying an image both in a transmissive mode and in a reflective mode with a high aperture ratio, though it does not employ a color-filter-on-array structure.

Japanese Laid-Open Patent Publication No. 11-101992 states that the disclosed display apparatus employs a semi-transmissive arrangement having transmissive regions and reflective regions, thereby allowing for the omission of a black matrix, which is normally provided on the counter substrate, thus realizing a high aperture ratio.

However, this arrangement only allows for the omission of a black matrix, and not the omission of a color filter, which is also normally provided on the counter substrate. It is still necessary to provide a color filter on the counter substrate. Therefore, the TFT array substrate and the counter substrate need to be attached to each other so that the pixel electrodes on the TFT array substrate are aligned with the filter portions of the color filter on the counter substrate, thus requiring some attachment margin.

### SUMMARY OF THE INVENTION

It is therefore an object of the present invention to provide a semi-transmissive display apparatus having a high definition and a high aperture ratio, by employing a color-filter-on-array structure in a semi-transmissive display apparatus.

In order to achieve the object set forth above, the present invention provides a semi-transmissive display apparatus, in which a plurality of pixels, each including a transmissive region and a reflective region, are arranged in a matrix pattern, the apparatus including: a device substrate including, for each of the plurality of pixels, a transparent electrode forming the transmissive region, a reflective plate forming the reflective region, and a switching device; a counter substrate including a common counter electrode and opposing the device substrate; and a display layer interposed between the device substrate and the counter substrate, wherein the device substrate is provided with a color filter.

In this structure, the color filter and the transparent electrode are provided on the device substrate, whereby there is little displacement between the transparent electrode and the color filter, while eliminating the need to provide the color filter on the counter substrate. Therefore, the counter substrate has a simple structure where the common counter electrode is provided on the substrate. Therefore, this structure hardly requires any attachment margin when attaching the substrates to each other. Furthermore, this structure eliminates the need to provide a black matrix for optically separating filter portions of different colors of the color filter from one another, thereby realizing a display apparatus having a high definition and a high aperture ratio.

In one embodiment, the transparent electrode is provided closer to the display layer than the color filter so as to cover the color filter, whereas the reflective plate is provided farther away from the display layer than the color filter and the transparent electrode so as to cover the switching device.

In this structure, the transparent electrode is provided on one side of the color filter that is closer to the display layer, whereby it is possible to apply a voltage across the display layer between the transparent electrode of the device substrate and the common counter electrode of the counter substrate. Moreover, the reflective plate is provided on one side of the color filter that is closer to the switching device so as to cover the switching device, whereby the reflective plate functions as a light-blocking film for the switching device, thereby suppressing the decrease in the switching characteristics of the switching device due to light.

In one embodiment, an interlayer insulating film is provided between the color filter and the transparent electrode so as to cover the reflective plate, and a thickness of the interlayer insulating film is determined so that a total optical path length for light traveling through the transmissive region is substantially equal to that for light traveling through the reflective region.

In a semi-transmissive display apparatus, the total optical path length for light traveling through the transmissive region is significantly different from that for light traveling through the reflective region. Specifically, light passes through the liquid crystal layer twice in the reflective region, whereas light passes through the liquid crystal layer only once in the transmissive region. Thus, there is a significant difference between the total optical path length in the transmissive region and that in the reflective region, thereby lowering the display quality. In the structure described above, the interlayer insulating film is provided between the color filter and the transparent electrode so as to cover the reflective plate, and the thickness thereof is determined so that the total optical path length for light traveling through the transmissive region is substantially equal to that for light traveling through the reflective region. Thus, in a color-filter-on-array structure, the optical path length in the transmissive region and that in the reflective region can be made substantially equal to each other, whereby it is possible to maintain a desirable display quality without causing a phase difference between the transmissive region and the reflective region.

In one embodiment, the interlayer insulating film is made of a resin.

With this structure, it is possible to easily form an interlayer insulating film having a thickness on the order of μm, which is required for matching the total optical path length for light traveling through the transmissive region and that for light traveling through the reflective region.

In one embodiment, the reflective plate is electrically connected to neither the switching device nor the transparent electrode.

With this structure, the reflective plate is in a floating structure, where it is electrically connected to neither the switching device nor the pixel electrode. In this way, the parasitic capacitance is small and the operation of the switching device is not adversely influenced. Thus, it is possible to realize a semi-transmissive liquid crystal display apparatus having a simple color-filter-on-array structure.

In one embodiment, the switching device is provided farther away from the display layer than the color filter, and the transparent electrode is electrically connected to the switching device via a contact hole formed in the color filter layer.

With this structure, the transparent electrode and the switching device can be connected to each other by a common method, and a desirable conductivity can be provided between the switching device and the transparent electrode layer.

Other objects, features, and advantages of the present invention will become apparent from the following description taken in conjunction with the accompanying drawings.

### BRIEF DESCRIPTION OF THE DRAWINGS

FIG. 1 is a schematic plan view illustrating a pixel region of a liquid crystal display apparatus according to Embodiment 1 of the present invention.

FIG. 2 is a schematic cross-sectional view illustrating a liquid crystal display apparatus according to Embodiment 2 of the present invention, taken along line II-II in FIG. 1.

FIG. 3 is a schematic cross-sectional view illustrating a liquid crystal display apparatus according to Embodiment 1 of the present invention, taken along line II-II in FIG. 1.

FIG. 4 is a schematic cross-sectional view illustrating a conventional transmissive liquid crystal display apparatus employing a color-filter-on-array structure.

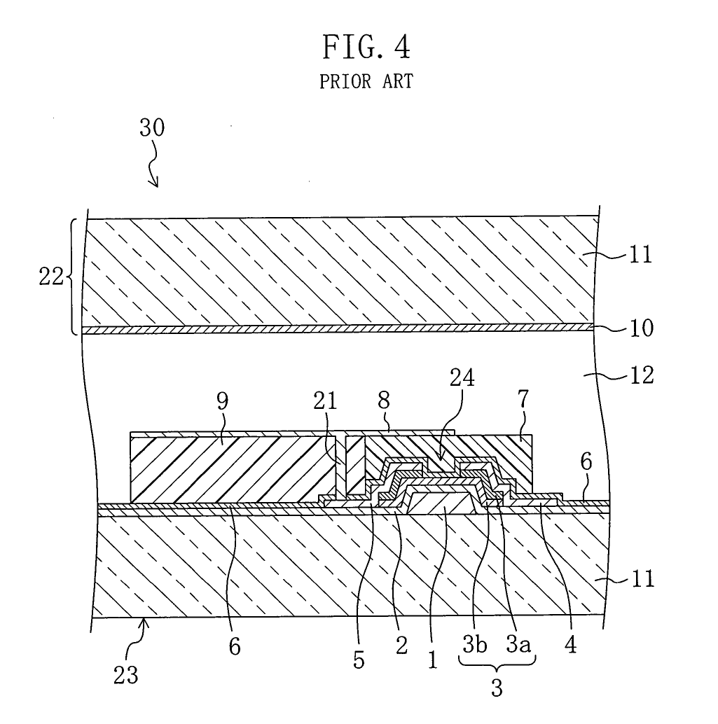

FIG. 5 is a schematic cross-sectional view illustrating a conventional reflective liquid crystal display apparatus employing a color-filter-on-array structure.

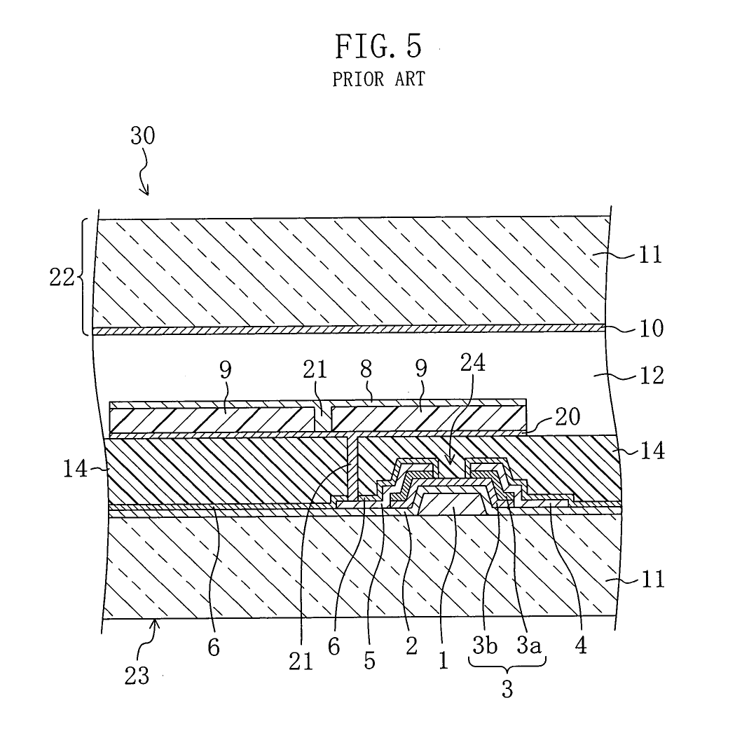

### DETAILED DESCRIPTION OF THE PREFERRED EMBODIMENTS

Preferred embodiments of the present invention will now be described in detail with reference to the drawings. The following embodiments are directed to a semi-transmissive liquid crystal display apparatus of a TFT-driven type, in which TFTs are used as switching devices. Note however that the liquid crystal display apparatus of the present invention is not limited thereto, and the present invention can be applied to any other suitable liquid crystal display apparatus of an active matrix-driven type, in which switching devices other than TFTs are used. Moreover, the present invention can also be applied to any suitable display apparatus other than liquid crystal display apparatuses.

### Embodiment 1

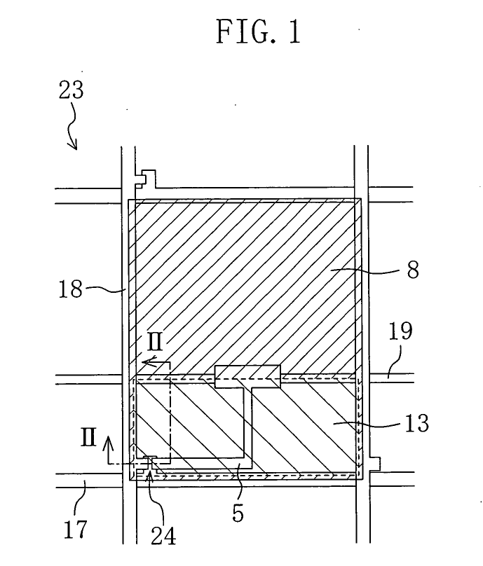

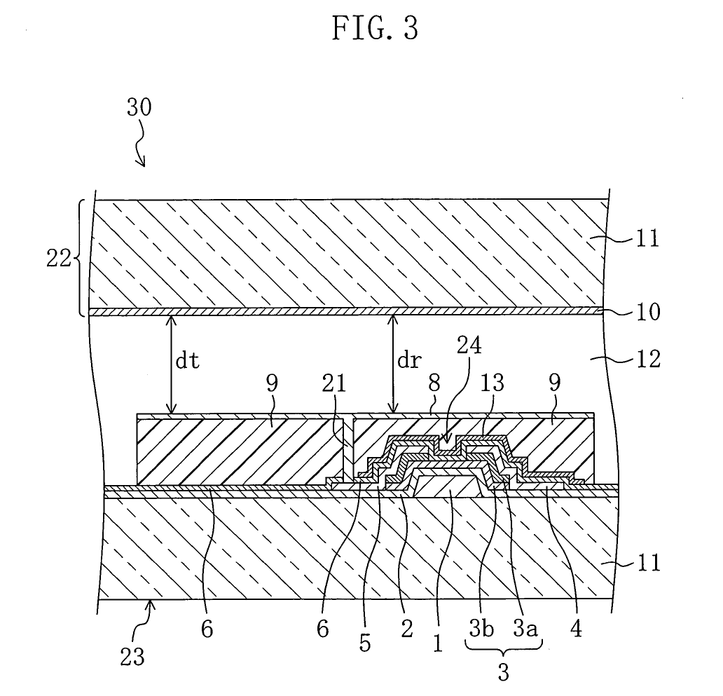

A semi-transmissive liquid crystal display apparatus according to Embodiment 1 of the present invention will now be described with reference to FIG. 1 and FIG. 3. Note that FIG. 1 is a schematic plan view illustrating a pixel region of a TFT array substrate 23 of a liquid crystal display apparatus 30 according to Embodiment 1 of the present invention, and FIG. 3 is a schematic cross-sectional view taken along line II-II in FIG. 1.

The liquid crystal display apparatus 30 includes the TFT array substrate 23, a counter substrate 22 provided so as to oppose the TFT array substrate 23, and a liquid crystal layer 12 provided so as to be interposed between the substrates.

The TFT array substrate 23 includes a plurality of gate lines 17 provided so as to extend parallel to each other on a glass substrate 11, a plurality of source lines 18 provided so as to extend parallel to each other in a direction perpendicular to the gate lines 17, and a TFT 24 provided at each intersection between the gate line 17 and the source line 18. The TFT array substrate 23 further includes a reflective plate 13, a color filter 9 and a transparent electrode 8, which are to be described later.

The gate line 17 is made of titanium, or the like. Moreover, storage capacitor lines 19 are provided so as to extend parallel to each other between the gate lines 17. Furthermore, a gate insulating film 2 made of silicon nitride, or the like, is provided so as to cover the gate line 17 and the storage capacitor line 19.

The storage capacitor line 19 is made of the same material as the gate line 17 and is form in the same layer as the gate line 17. The storage capacitor line 19 is connected to a drain electrode 5 of the TFT 24 to be described later, forming a storage capacitor. Normally, when the pixel capacitor for storing a charge is made up only of the liquid crystal capacitor, the image-holding capability may be insufficient and the influence of the parasitic capacitance may be significant. Therefore, the storage capacitor is provided in order to ensure a sufficient display-data-holding capability and a desirable image display operation.

The source line 18 is made of titanium, or the like, and is provided on the gate insulating film 2.

The TFT 24 includes a gate electrode 1 being a protruding portion of the gate line 17, a semiconductor film 3, a source electrode 4 being a protruding portion of the source line 18 and extending over the semiconductor film 3, and the drain electrode 5 extending over the semiconductor film 3 so as to oppose the source electrode 4. Furthermore, a protection film 6 made of silicon nitride, or the like, is provided so as to cover the TFT 24.

The semiconductor film 3 is provided over the gate electrode 1 with the gate insulating film 2 being interposed therebetween, and includes an intrinsic amorphous silicon layer 3b on the gate insulating film 2 and an n+ amorphous silicon layer 3a on the intrinsic amorphous silicon layer 3b.

The reflective plate 13, made of aluminum, or the like, is provided so as to cover the TFT 24 with the protection film 6 being interposed therebetween, and functions also as a light-blocking film for preventing light from entering the TFT 24. The reflective plate 13 is provided in a floating structure, where it is electrically connected to neither the TFT 24 nor the transparent electrode 8, or anywhere else.

The color filter 9 is made up of filter portions, each of which is made of a photosensitive resist material containing one of red, green and blue pigments dispersed therein, and is provided so as to cover the reflective plate 13 and to extend substantially entirely across each pixel area, which is defined by two adjacent gate lines 17 and two adjacent source lines 18. A red, green or blue filter portion is provided for each pixel.

The transparent electrode 8, made of ITO (Indium Tin Oxide), or the like, is provided so as to cover the color filter 9 and is connected to the drain electrode 5 of the TFT 24 via a contact hole 21 formed in the color filter 9.

The counter substrate 22 includes a common counter electrode 10 made of ITO, or the like, on the glass substrate 11.

The liquid crystal layer 12 is made of a nematic liquid crystal material having electrooptical properties.

The liquid crystal display apparatus 30 displays an image as follows. In each pixel, when a predetermined voltage is applied to the gate electrode 1 of the TFT 24 via the gate line 17, thereby turning the TFT 24 ON, a charge flowing in via the drain electrode 5 is held by the liquid crystal capacitor formed between the transparent electrode 8 and the common counter electrode 10 and the storage capacitor as a signal voltage is applied to the source electrode 4 via the source line 18. The orientation of the liquid crystal molecules in the liquid crystal layer 12 is changed according to the amount of charge, thereby accordingly changing the light transmissivity of the liquid crystal layer 12, thereby displaying an image.

In the liquid crystal display apparatus 30, the color filter 9 and the transparent electrode 8 are formed on the substrate on which the TFTs 24 are formed, i.e., the TFT array substrate 23, whereby there is little displacement between the transparent electrode 8 and the color filter 9, while eliminating the need to provide the color filter 9 on the counter substrate 22. Therefore, the counter substrate 22 has a simple structure where the common counter electrode 10 is provided on the substrate. Thus, the counter substrate 22 is not divided into sections by elements on the substrate, and hardly requires any attachment margin. Furthermore, this structure eliminates the need to provide a black matrix for optically separating filter portions of different colors of the color filter 9 from one another, thereby realizing a liquid crystal display apparatus having a high definition and a high aperture ratio. Moreover, the reflective plate 13, provided so as to cover the TFT 24, functions as a light-blocking film for preventing light from entering the TFT 24. This ensures a sufficient light-blocking property around the TFT 24, thereby suppressing the decrease in the off-state characteristics of the TFT 24. Moreover, since the reflective plate 13 has a floating structure and is not electrically connected to any other elements, the parasitic capacitance is small and the operation of the TFT 24 is not adversely influenced. Thus, it is possible to realize a semi-transmissive liquid crystal display apparatus having a simple color-filter-on-array structure.

Next, a method for manufacturing a liquid crystal display apparatus according to Embodiment 1 of the present invention will be described.

Step of Producing TFT Array Substrate

First, a metal film made of titanium, or the like, is formed by a sputtering method on the glass substrate 11 made of a non-alkaline glass, and then patterned by a photo-engraving process (hereinafter referred to as “PEP”) to form the gate lines 17, the gate electrodes 1 and the storage capacitor lines 19.

Then, silicon nitride, or the like, is deposited by a CVD (Chemical Vapor Deposition) method on the gate lines 17, the gate electrodes 1 and the storage capacitor lines 19 to form the gate insulating film 2.

Then, an intrinsic amorphous silicon film and a phosphorus-doped n+ amorphous silicon film are successively formed on the gate insulating film 2 by a CVD method, and then patterned into an island-shaped pattern by PEP, thereby forming the semiconductor film 3 including the intrinsic amorphous silicon layer 3b and the n+ amorphous silicon layer 3a.

Then, a metal film made of titanium, or the like, is formed by a sputtering method on the gate insulating film 2, on which the semiconductor film 3 has been formed, and then patterned by PEP to form the source lines 18, the source electrodes 4 and the drain electrodes 5.

Then, the n+ amorphous silicon layer 3a is etched by using the source electrode 4 and the drain electrode 5 as a mask, thereby forming a channel section.

Then, silicon nitride, or the like, is deposited by a CVD method on the source electrodes 4 and the drain electrodes 5, thereby forming the protection film 6.

Then, a metal film made of aluminum, or the like, is formed by a sputtering method on the protection film 6, and then patterned by PEP to form the reflective plate 13 covering the TFT 24.

Then, a photosensitive resist material, or the like, containing one of red, green and blue pigments dispersed therein is applied on the protection film 6 and the reflective plate 13, and then patterned by PEP to form filter portions of the selected color. The step is repeated for the other two colors, thus forming the color filter 9 including filter portions of three colors such that a filter portion of one color is provided for each pixel.

Then, the contact hole 21 is formed by PEP so that it runs through the color filter 9 and the protection film 6 to reach the drain electrode 5.

Then, a transparent conductive film made of ITO, or the like, is formed by a sputtering method on the color filter 9, and then patterned by PEP to form the transparent electrodes 8.

Thus, the TFT array substrate 23 is produced.

Step of Producing Counter Substrate

The counter substrate 22 can be produced by forming a transparent conductive film made of ITO, or the like, by a sputtering method on the glass substrate 11 made of a non-alkaline glass.

Step of Producing Liquid Crystal Display Apparatus

First, a polyimide resin, or the like, is applied on the TFT array substrate 23 and the counter substrate 22 by flexography, and then baked. Then, an alignment process is performed by rubbing the surface of the alignment film in a predetermined direction.

Then, a sealant made of a thermosetting epoxy resin, or the like, is applied by screen printing on one of the TFT array substrate 23 and the counter substrate 22 in a frame-shaped pattern broken at the liquid crystal injection port. Spherical plastic beads made of a polymer such as a polystyrene polymer are dispersed on the other one of the TFT array substrate 23 and the counter substrate 22. The diameter of the spherical plastic beads corresponds to the thickness of the liquid crystal layer.

Then, the TFT array substrate 23 and the counter substrate 22 are attached to each other, and the sealant is cured to form an empty cell. The color filter 9 and the transparent electrode 8 are formed on the TFT array substrate 23, whereby there is little displacement between the color filter 9 and the transparent electrode 8, while eliminating the need to provide the color filter 9 on the counter substrate 22. Therefore, the counter substrate 22 has a simple structure where the common counter electrode 10 is provided on the substrate. Thus, even if there is some misalignment between the TFT array substrate 23 and the counter substrate 22 when attaching them together, the misalignment does not lead to a displacement between the color filter 9 and the transparent electrode 8. Therefore, the liquid crystal display apparatus 30 provides a desirable productivity because it is not necessary to perform the substrate attachment step with a high precision.

Then, a liquid crystal material is injected into the gap between the TFT array substrate 23 and the counter substrate 22 of the empty cell by a vacuum filling method, thereby forming the liquid crystal layer 12. Then, a UV-curable resin is applied to the liquid crystal injection port, and is irradiated with UV light to cure the UV-curable resin, thereby sealing the injection port.

The liquid crystal display apparatus 30 of the present invention can be manufactured as described above.

As described above, the liquid crystal display apparatus 30 of the present invention provides a desirable productivity because it is not necessary to perform the substrate attachment step with a high precision. Furthermore, this structure eliminates the need to provide a black matrix for optically separating filter portions of different colors of the color filter from one another, thereby realizing a semi-transmissive liquid crystal display apparatus having a high definition and a high aperture ratio.

### Embodiment 2

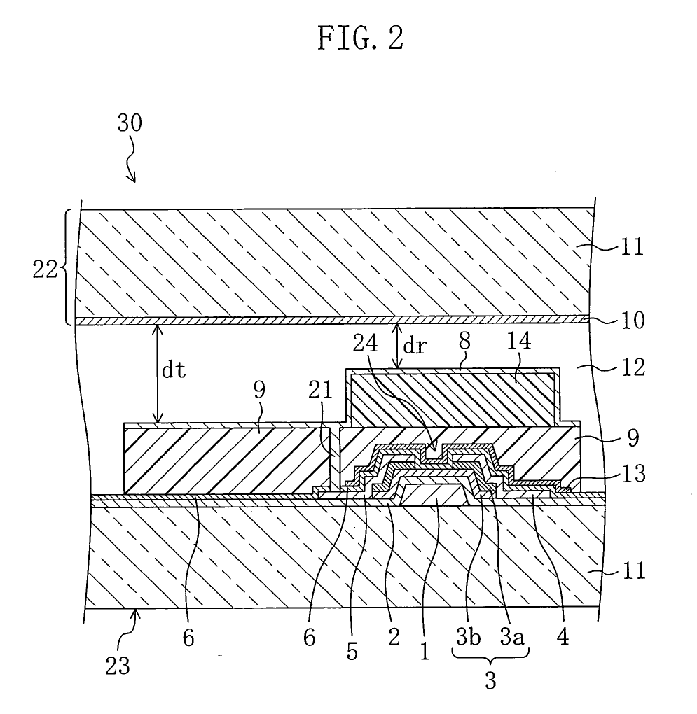

A semi-transmissive liquid crystal display apparatus according to Embodiment 2 of the present invention will now be described with reference to FIG. 2. Note that FIG. 2 is a schematic cross-sectional view illustrating the TFT array substrate 23 of the liquid crystal display apparatus 30 according to Embodiment 2 of the present invention, and corresponds to FIG. 3.

In the liquid crystal display apparatus 30, the interlayer insulating film 14 is provided between the color filter 9 and the transparent electrode 8 so as to cover the reflective plate 13. Other than this, the liquid crystal display apparatus 30 of the present embodiment is similar to that of Embodiment 1, and common components will be denoted by the same reference numerals and will not be further described below.

The interlayer insulating film 14 is made of a photosensitive acrylic resin, or the like. The thickness of the interlayer insulating film 14 is determined so that the total optical path length for light traveling through the transmissive region is substantially equal to that for light traveling through the reflective region. Therefore, the thickness dt of the liquid crystal layer 12 in the transmissive region is about twice the thickness dr of the liquid crystal layer 12 in the reflective region.

Thus, in the liquid crystal display apparatus 30, the interlayer insulating film 14 for matching the total optical path length for light traveling through the transmissive region with that for light traveling through the reflective region is provided between the color filter 9 and the transparent electrode 8 so as to cover the reflective plate 13. As a result, in addition to the functions and effects of Embodiment 1, the liquid crystal display apparatus 30 of the present embodiment can maintain a desirable display quality without causing a phase difference between the transmissive region and the reflective region.

A method for manufacturing the liquid crystal display apparatus 30 according to Embodiment 2 of the present invention will not be described in detail as it is similar to that of Embodiment 1, except for the additional formation of the interlayer insulating film 14 on the color filter 9.

A specific method for forming the interlayer insulating film 14 will now be described.

First, a photosensitive acrylic resin, or the like, is applied on the color filter 9, and then patterned by PEP to form the interlayer insulating film 14 in a pattern corresponding to the pattern of the reflective plate 13.

Then, a transparent conductive film made of ITO, or the like, is formed by a sputtering method on the color filter 9 and the interlayer insulating film 14, and then patterned by PEP to form the transparent electrode 8.

In this way, the interlayer insulating film 14 for matching the total optical path length for light traveling through the transmissive region with that for light traveling through the reflective region can be formed between the color filter 9 and the transparent electrode 8, thereby realizing a semi-transmissive liquid crystal display apparatus that provides a desirable display quality without causing a phase difference between the transmissive region and the reflective region.

While the TFT array substrate and the counter substrate are both produced from a base substrate made of a glass in the embodiments described above, the present invention is not limited to this. Typically, a plastic substrate can easily shrink/expand due to heat, moisture, etc. Therefore, if a plastic substrate is used as a base substrate, a misalignment is likely to occur when attaching the substrates to each other. According to the present invention, however, it is not necessary to perform the substrate attachment step with a high precision. Therefore, the attachment step is easy even if a plastic substrate is used. Thus, the advantages of the present invention may be more pronounced when the TFT array substrate and the counter substrate are produced from a base substrate made of a plastic material.

While the present invention has been described in preferred embodiments, it will be apparent to those skilled in the art that the disclosed invention may be modified in numerous ways and may assume many embodiments other than those specifically set out and described above. Accordingly, it is intended by the appended claims to cover all modifications of the invention that fall within the true spirit and scope of the invention.

What is claimed is:

1. A semi-transmissive display apparatus, in which a plurality of pixels, each including a transmissive region and a reflective region, are arranged in a matrix pattern, the apparatus comprising:
a device substrate including, for each of the plurality of pixels, a transparent electrode forming the transmissive region, a reflective plate forming the reflective region, and a switching device;
a counter substrate including a common counter electrode and opposing the device substrate; and
a display layer interposed between the device substrate and the counter substrate,
wherein the device substrate is provided with a color filter.

2. The semi-transmissive display apparatus of claim 1, wherein the transparent electrode is provided closer to the display layer than the color filter so as to cover the color filter, whereas the reflective plate is provided farther away from the display layer than the color filter and the transparent electrode so as to cover the switching device.

3. The semi-transmissive display apparatus of claim 2, wherein an interlayer insulating film is provided between the color filter and the transparent electrode so as to cover the reflective plate, and a thickness of the interlayer insulating film is determined so that a total optical path length for light traveling through the transmissive region is substantially equal to that for light traveling through the reflective region.

4. The semi-transmissive display apparatus of claim 3, wherein the interlayer insulating film is made of a resin.

5. The semi-transmissive display apparatus of claim 2, wherein the reflective plate is electrically connected to neither the switching device nor the transparent electrode.

6. The semi-transmissive display apparatus of claim 2, wherein:
the switching device is provided farther away from the display layer than the color filter; and
the transparent electrode is electrically connected to the switching device via a contact hole formed in the color filter.
